(19) United States
(12) Patent Application Publication
(10) Pub. No.: US 2014/0015791 A1
(43) Pub. Date: Jan. 16, 2014

(54) TOUCH PANEL DRIVING DEVICE AND DRIVING METHOD THEREOF

(71) Applicant: HANNSTAR DISPLAY CORPORATION, New Taipei City (TW)

(72) Inventors: Chien-Hsiang Huang, Tainan City (TW); Kun-Hua Tsai, Tainan City (TW); Jun-Shih Chung, Taichung City (TW); Chun-Hsi Chen, Pingtung County (TW)

(73) Assignee: HANNSTAR DISPLAY CORPORATION, New Taipei City (TW)

(21) Appl. No.: 13/653,425

(22) Filed: Oct. 17, 2012

(30) Foreign Application Priority Data
Jul. 10, 2012 (CN) 201210238498.6

(51) Int. Cl. G06F 3/044

(52) U.S. Cl. 345/174; 178/18.06

(57) ABSTRACT

A touch panel driving device is provided, which is adapted to drive a capacitive touch panel and includes a driving part, a power supply part and a control part. The driving part is configured to sequentially generate a plurality of scan signals with the level of an operation voltage in response to the operation voltage, so as to drive the capacitive touch panel. The power supply part is coupled to the driving part, and configured to supply the operation voltage to the driving part. The control part is coupled to the driving part and the power supply part, and configured to control operations of the driving part and the power supply part and adjust the operation voltage supplied by the power supply part in response to different touch conditions, so as to change the amplitudes of the scan signals.

### CROSS-REFERENCE TO RELATED APPLICATION

This application claims the priority benefit of China application serial no. 201210238498.6, filed on Jul. 10, 2012. The entirety of the above-mentioned patent application is hereby incorporated by reference herein and made a part of this specification.

### BACKGROUND OF THE INVENTION

1. Field of the Invention

The present invention generally relates to a driving device and a driving method, and more particularly, to a touch panel driving device and a driving method thereof.

2. Description of Related Art

With the rapid development and progress of wireless mobile communications and consumer electronics products, in order to achieve more convenient usage, more compact size and more intuitive operation to eliminate the gap between user and computer devices, many information products have converted their input devices from the traditional keyboard or mouse into touch panel. Among the above-mentioned touch panel input devices, the capacitive touch panel technology is the most prosperous and popular today.

During manipulating a touch device with the capacitive touch panel, users usually use a finger or a touch stylus as the medium for touching the capacitive touch panel touch. In the case by using finger-touching media, due to the large contact area between the finger and the capacitive touch panel, only a scan signal with a lower level output from a driving device is allowed to make the capacitive touch panel generate a recognizable sensed signal(s). However, for the case by using a touch stylus, due to the smaller contact area between the touch stylus and the capacitive touch panel, the capacitance variation generated between electrodes in the capacitive touch panel is relatively lower. When the level of the input scan signal is too low, it is unable to recognize and determine out whether or not the sensed signal(s) generated by the capacitive touch panel is/are the real touch signal(s) of the touch stylus or noise solely. In this regard, to enable a capacitive touch panel simultaneously using finger or touch stylus as touching media, the scan signal output from the driving device must reach a certain voltage level for driving the capacitive touch panel, which makes reducing the whole power consumption of the touch device quite hard.

### SUMMARY OF THE INVENTION

Accordingly, the present invention is directed to a touch panel driving device, which is able to switch and output scan signals with corresponding driving capacity according to different touching conditions so as to reduce the power consumption.

The invention provides a touch panel driving method, which is able to switch and use scan signals with different driving capacity according to different touching conditions so as to reduce the power consumption.

The invention provides a touch panel driving device, in which the driving device is adapted to drive a capacitive touch panel and includes a driving part, a power supply part and a control part. The driving part is configured to sequentially generate a plurality of scan signals with the level of an operation voltage in response to the operation voltage so as to drive the capacitive touch panel. The power supply part is coupled to the driving part, and configured to supply the operation voltage to the driving part. The control part is coupled to the driving part and the power supply part, and configured to control operations of the driving part and the power supply part and adjust the operation voltage supplied by the power supply part in response to different touch conditions so as to change the amplitudes of the scan signals.

In an embodiment of the present invention, the above-mentioned power supply part includes a power-generating unit and a power switching unit. The power-generating unit is configured to at least generate a first supplying voltage and a second supplying voltage, in which the level of the first supplying voltage is less than the level of the second supplying voltage. The power switching unit is coupled to the power-generating unit, the driving part and the control part, and configured to switch and output one of the first supplying voltage and the second supplying voltage as the operation voltage in response to the control of the control part.

In an embodiment of the present invention, the above-mentioned control part, in response to a user command, controls the power switching unit to output one of the first supplying voltage and the second supplying voltage as the operation voltage.

In an embodiment of the present invention, the above-mentioned control part controls the power switching unit according to a plurality of sensed signals generated by the capacitive touch panel so as to switch and output one of the supplying voltages as the operation voltage.

In an embodiment of the present invention, the above-mentioned control part is further configured to analyze and determine whether or not the signal to noise ratio (SNR) of the sensed signals exceeds a threshold value, in which when the control part determines that the signal to noise ratio (SNR) of the sensed signals exceeds the threshold value, the control part controls the power switching unit to switch and output the first supplying voltage as the operation voltage; when the control part determines that the SNR of the sensed signals does not exceed the threshold value, the control part controls the power switching unit to switch and output the second supplying voltage as the operation voltage; the level of the first supplying voltage is less than the level of the second supplying voltage, such that the amplitude of each of the scan signals with the level of the first supplying voltage is less than the amplitude of each of the scan signals with the level of the second supplying voltage.

In an embodiment of the present invention, the above-mentioned power supply part includes a dynamic power-generating unit. The dynamic power-generating unit is configured to dynamically generate an adjustable voltage as the operation voltage in response to the control of the control part.

In an embodiment of the present invention, the above-mentioned control part controls the dynamic power-generating unit to dynamically generate the adjustable voltage according to a plurality of sensed signals generated by the capacitive touch panel.

In an embodiment of the present invention, the above-mentioned control part further controls the dynamic power-generating unit to dynamically generate the adjustable voltage by analyzing the SNR of the sensed signals.

In an embodiment of the present invention, the above-mentioned driving part includes an analog front-end (AFE) processor and a level shifter. The AFE processor is coupled to the control part to sequentially generate a plurality of first scan signals, in which the AFE processor receives a plurality of sensed signals generated by the capacitive touch panel and thereby performing an analog-to-digital conversion on the sensed signals, so as to return the converted sensed signals to the control part. The level shifter is coupled to the power supply part and the AFE processor, in which the level shifter receives the first scan signals and, in response to the operation voltage, adjusts the amplitudes of the first scan signals to thereby sequentially generate a plurality of second scan signals with the level of the operation voltage.

In an embodiment of the present invention, the above-mentioned control part includes a microprocessor. The microprocessor receives a plurality of sensed signals returned by the driving part and thereby performing a signal processing on the sensed signals, so as to recognize touch event on the capacitive touch panel, in which the microprocessor correspondingly controls the power supply part in response to different touch conditions.

The invention also provides a touch panel driving method, which is adapted for driving a capacitive touch panel and includes: sequentially generating a plurality of scan signals with level of an operation voltage; adjusting the operation voltage in response to different touch conditions; and changing amplitudes of the scan signals in response to the adjusted operation voltage and thereby driving the capacitive touch panel.

In an embodiment of the present invention, the above-mentioned step of adjusting the operation voltage in response to different touch conditions includes: switching and outputting one of a first supplying voltage and a second supplying voltage in response to a user command as the operation voltage.

In an embodiment of the present invention, the above-mentioned step of adjusting the operation voltage in response to different touch conditions includes: switching and outputting one of a plurality of supplying voltages as the operation voltage according to a plurality of sensed signals generated by the capacitive touch panel.

In an embodiment of the present invention, the above-mentioned supplying voltages comprise a first supplying voltage and a second supplying voltage, and the step of switching and outputting one of the supplying voltages as the operation voltage according to the sensed signals generated by the capacitive touch panel includes: receiving the sensed signals; analyzing and determining whether or not the SNR of the sensed signals exceeds a threshold value; when the SNR of the sensed signals exceeds the threshold value, switching and outputting the first supplying voltage as the operation voltage; and when the SNR of the sensed signals does not exceed the threshold value, switching and outputting the second supplying voltage as the operation voltage, in which the level of the first supplying voltage is less than the level of the second supplying voltage, and the amplitude of each of the scan signals with the level of the first supplying voltage is less than the amplitude of each of the scan signals with the level of the second supplying voltage.

In an embodiment of the present invention, when the operation voltage is the first supplying voltage, the above-mentioned step of changing the amplitudes of the scan signals in response to the adjusted operation voltage and thereby driving the capacitive touch panel includes: changing the amplitudes of a plurality of first scan signals according to the first supplying voltage so as to output a plurality of second scan signals with the level of the first supplying voltage; and using the second scan signals to drive the capacitive touch panel.

In an embodiment of the present invention, when the operation voltage is the second supplying voltage, the above-mentioned step of changing the amplitudes of the scan signals in response to the adjusted operation voltage and thereby driving the capacitive touch panel includes: changing the amplitudes of a plurality of first scan signals according to the second supplying voltage so as to output a plurality of second scan signals with the level of the second supplying voltage; and using the second scan signals to drive the capacitive touch panel.

In an embodiment of the present invention, the above-mentioned step of adjusting the operation voltage in response to different touch conditions includes: dynamically generating an adjustable voltage as the operation voltage according to a plurality of sensed signals generated by the capacitive touch panel.

In an embodiment of the present invention, the above-mentioned step of dynamically generating the adjustable voltage as the operation voltage according to the sensed signals generated by the capacitive touch panel includes: receiving the sensed signals; analyzing the SNR of the sensed signals; and dynamically generating the adjustable voltage as the operation voltage according to the SNR of the sensed signals.

In an embodiment of the present invention, the step of changing the amplitudes of the scan signals in response to the adjusted operation voltage includes: changing amplitudes of a plurality of first scan signals according to the operation voltage so as to output a plurality of second scan signals with the level of the operation voltage.

Based on the description above, the touch panel driving device and the driving method thereof in the embodiments of the invention are able to manually input the user commands through an application (AP), or automatically provide the scan signals with corresponding driving capacity to drive the capacitive touch panel according to the sensed signals under different touch conditions, which enables a driving device using the above-mentioned driving method saving the power consumption during driving.

Reference will now be made in detail to the present preferred embodiments of the invention, examples of which are illustrated in the accompanying drawings. Wherever possible, the same reference numbers are used in the drawings and the description to refer to the same or like parts.

### BRIEF DESCRIPTION OF THE DRAWINGS

FIG. 1 is a schematic diagram of a driving device 100 according to an embodiment of the present invention.

FIG. 2 is a flowchart of the steps of a touch panel driving method according to the embodiment of FIG. 1.

FIG. 3 is a schematic diagram of a driving device 300 according to an embodiment of the present invention.

FIG. 4 is a flowchart of the steps of a touch panel driving method according to the embodiment of FIG. 3.

FIG. 5 is a schematic diagram of a driving device 500 according to an embodiment of the present invention.

FIG. 6 is a flowchart of the steps of a touch panel driving method according to the embodiment of FIG. 5.

### DESCRIPTION OF THE EMBODIMENTS

Embodiments of the invention provide a touch panel driving device and a driving method thereof, which can further adjust the voltage levels of the scan signals output therefrom according to different touch conditions so as to save the power consumption during driving of the above-mentioned driving device. For simplicity, some feasible embodiments are given to explain the invention. In addition, whenever possible, the same reference numbers are used in the drawings and the description to refer to the same or like components, parts or steps.

FIG. 1 is a schematic diagram of a driving device 100 according to an embodiment of the present invention. In the embodiment, the driving device 100 is configured to drive a capacitive touch panel 10. Referring to FIG. 1, the driving device 100 includes a driving part 110, a power supply part 120 and a control part 130. The driving part is for sequentially generating a plurality of scan signals Tx1-Txm with an operation voltage Vs in response to the operation voltage Vs, in which m is a positive integer and is determined by the number of sensing lines of the capacitive touch panel 10, but the present invention is not limited thereto.

The power supply part 120 is coupled to the driving part 110, and configured for supplying the operation voltage Vs to the driving part 110. The control part 130 is coupled to the driving part 110 and the power supply part 120, and configured for controlling the operations of the driving part 110 and the power supply part 120.

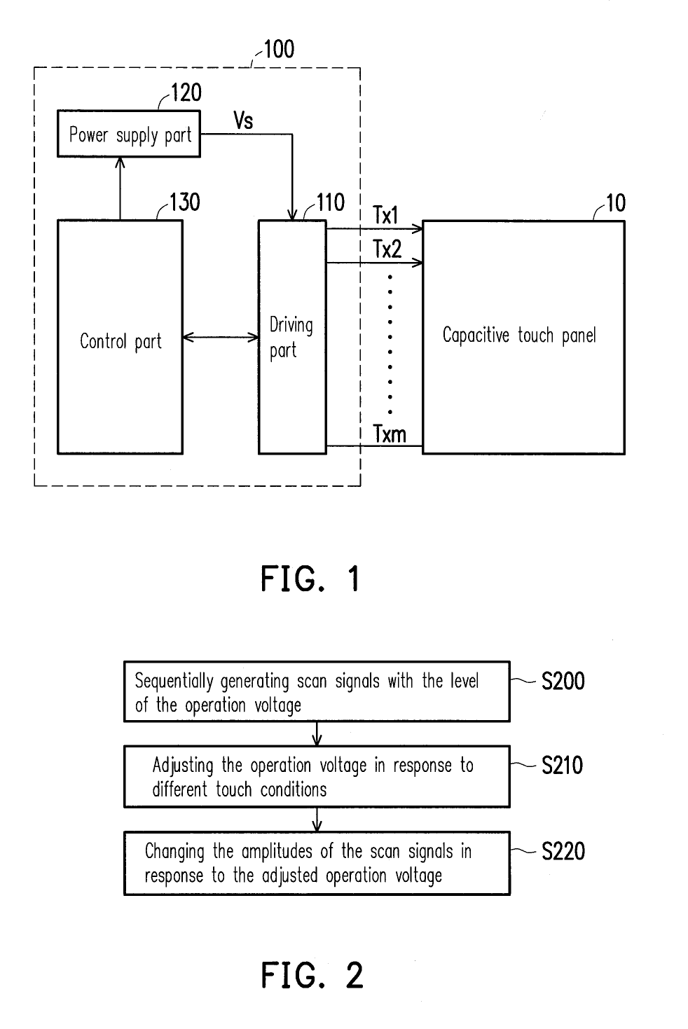

Specifically, the driving method of the capacitive touch panel 10 can be shown by FIG. 2, which is a flowchart of the steps of a touch panel driving method according to the embodiment of FIG. 1. Referring to FIGS. 1 and 2, first, the driving part 110 would sequentially generate a plurality of scan signals Tx1-Txm with the level of the operation voltage Vs in response to the initial operation voltage Vs (step S200) so as to drive the capacitive touch panel 10. Next, the control part 130 would adjust the operation voltage Vs provided by the power supply part 120 in response to different touch conditions (step S210) so that the driving part 110 changes the amplitudes of the scan signals Tx1-Txm in response to the adjusted operation voltage Vs and thereby drives the capacitive touch panel 10 (step S220).

In more details, the above-mentioned touch conditions are, for example, by using different touch conditions to conduct touching operation on the capacitive touch panel 10. Different touch media (for example, finger or touch stylus) would have different intensities of the sensed signals generated by the capacitive touch panel 10, so that the driving device 100 of the embodiment can use the scan signals Tx1-Txm with corresponding driving capacities to drive the capacitive touch panel 10 according to different touch conditions, which is advantageous to save power consumption of the capacitive touch panel 10.

Taking an example, when finger is used to conduct touching operation on the capacitive touch panel 10, since the contact area between the finger and the capacitive touch panel 10 is larger so that the capacitance variation between the electrodes on the capacitive touch panel 10 and the intensity of the sensed signal generated by the capacitive touch panel 10 are accordingly larger. As a result, the driving part 110 is required to provide scan signals Tx1-Txm with lower driving capacity (i.e., the scan signals with smaller amplitudes) only to make the capacitive touch panel 10 generate recognizable sense signals.

On the contrary, when touch stylus is used to conduct touching operation on the capacitive touch panel 10, since the contact area between the finger and the capacitive touch panel 10 is smaller so that the capacitance variation between the electrodes on the capacitive touch panel 10 and the intensity of the sensed signal generated by the capacitive touch panel 10 are accordingly smaller. At the time, if the driving part 110 drives the capacitive touch panel 10 still through the scan signals Tx1-Txm with lower driving capacity, the sensed signal generated by the capacitive touch panel 10 would be easily affected by noise to hardly recognize true touching actions/events. Therefore, the driving part 110 must provide the scan signals Tx1-Txm with higher driving capacity (i.e., the scan signals with larger amplitudes) to make the capacitive touch panel 10 generate sense signals strong enough to be recognized.

In a driving device of a usual capacitive touch panel, to simultaneously support different touch media for touching actions, the usual driving device, no matter by using which touch medium, must provide the scan signals with higher driving capacity to drive the capacitive touch panel, which leads to unnecessary higher power consumption.

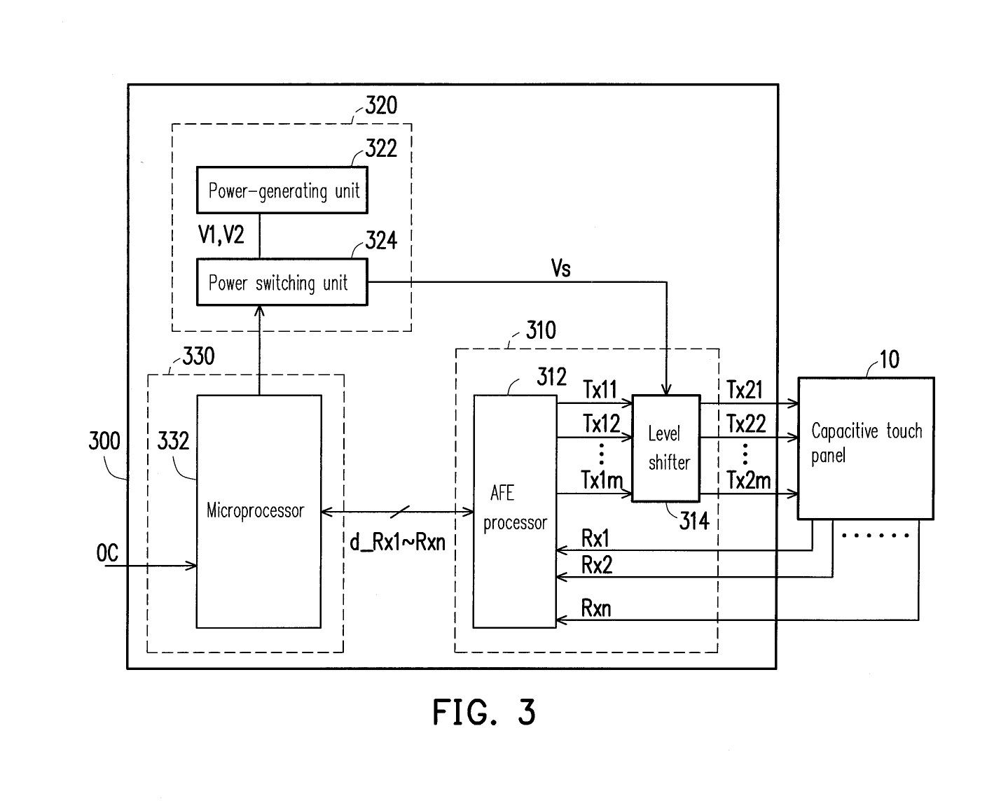

To explain the feasibility of the driving part 110, the power supply part 120 and the control part 130 in the application practice, hardware components shown by FIG. 3 are employed to fulfill the functions, which the present invention is not limited to. FIG. 3 is a schematic diagram of a driving device 300 according to an embodiment of the present invention.

Referring to FIG. 3, the driving device 300 includes a driving part 310, a power supply part 320 and a control part 330. In the embodiment, the driving part 310 further includes an AFE processor 312 and a level shifter 314. The power supply part 320 includes a power-generating unit 322 and a power switching unit 324, while the control part 330 includes a microprocessor 332.

In the driving part 310, the AFE processor 312 is coupled to the microprocessor 332 of the control part 330 for sequentially generating a plurality of first scan signals Tx1-Tx1m, in which the AFE processor 312 receives a plurality of sensed signals Rx1-Rxn generated by the capacitive touch panel 10, and thereby performing an analog-to-digital conversion on the sensed signals Rx1-Rxn, so as to return the converted sensed signals d_Rx1_-d_Rxn to the microprocessor 332, in which n is a positive integer and determined by the number of sensing lines of the capacitive touch panel 10, but the present invention is not limited thereto. The level shifter 314 is coupled to the power switching unit 324 of the power supply part 320 and the AFE processor 312, in which the level shifter 314 receives the first scan signals Tx11-Tx1m and adjusts the amplitudes of the first scan signals Tx11-Tx1m in response to the operation voltage Vs so as to thereby sequentially generate a plurality of second scan signals Tx21-Tx2m with the level of the operation voltage Vs.

In the power supply part 320, the power-generating unit 322 generates a first supplying voltage V1 and a second supplying voltage V2, in which the level of the first supplying voltage V1 is less than the level of the second supplying voltage V2. The power switching unit 324 is coupled to the power-generating unit 322, the level shifter 314 of the driving part 310 and the microprocessor 332 of the control part 330. The power switching unit 324 at least generates the first supplying voltage V1 and the second supplying voltage V2, and switches and outputs one of the first supplying voltage V1 and the second supplying voltage V2 as the operation voltage Vs according to the control of the power-generating unit 322.

In the control part 330, the microprocessor 332 receives a plurality of converted sensed signals d_Rx1_-d_Rxn returned by the AFE processor 312 and thereby performs a signal processing on the sensed signals d_Rx1_d_Rxn to recognize the touching actions/events on the capacitive touch panel 10, in which the microprocessor 332 correspondingly controls the power-generating unit 322 in the power supply part 320 in response to different touch conditions.

In the embodiment, the power supply part 320 uses the power switching unit 324 to switch and output one of the first supplying voltage V1 and the second supplying voltage V2 generated by the power-generating unit 322 as the operation voltage Vs so as to generate the operation voltage Vs with different levels. However, in other embodiments, the power supply part can dynamically generate the operation voltage directly according to different touch conditions, which would be explained by the relevant embodiment later and the present invention is not limited thereto.

In more details, the driving device 300 can fulfil functions in response to different touch conditions through different control ways. By inputting a user command OC or determining the SNR of the sensed signals Rx1-Rxn to determine the operation voltage Vs provided by the power supply part 320, such that the control part 330 is able to control the power supply part 320 in response to different touch conditions, in which the touching state of finger or touch stylus serves as the touch condition.

First, in terms of the control way by inputting the user command to control the driving device 300, the operator can use an AP to input a user command OC corresponding to finger or touch stylus to the microprocessor 332. At the time, the microprocessor 332 controls the power switching unit 324 to switch and output one of the first supplying voltage V1 and the second supplying voltage V2 as the operation voltage Vs according to the user command OC, and the level shifter 314 thereby adjusts the amplitude of each of the first scan signals Tx11-Tx1m according to the operation voltage Vs and outputs the second scan signals Tx21-Tx2m with the level of the operation voltage Vs.

For example, when the operator wants to use finger to conduct touching operation, the operator can input a user command OC corresponding to the finger touching mode in advance. At the time, the microprocessor 332 controls the power switching unit 324 to switch and output the first supplying voltage V1 with a lower level as the operation voltage Vs according to the user command OC, and the level shifter 314 thereby further adjusts the amplitudes of the first scan signals Tx11-Tx1m to output the second scan signals Tx21-Tx2m with the level of the first supplying voltage V1. The amplitudes of the second scan signals Tx21-Tx2m herein are less than or equal to the amplitudes of the first scan signals Tx11-Tx1m. In other words, in some embodiments, the level shifter 314 can, depending on the design consideration, further reduce the amplitudes of the first scan signals Tx11-Tx1m or, instead of using the level shifter 314, the first scan signals Tx11-Tx1m are directly output to serve as the second scan signals Tx21-Tx2m, which the present invention is not limited thereto.

On the other hand, when the operator wants to use touch stylus to conduct touching operation, the operator can input a user command OC corresponding to the stylus touching mode in advance. At the time, the microprocessor 332 controls the power switching unit 324 to switch and output the second supplying voltage V2 with a higher level as the operation voltage Vs according to the user command OC, and the level shifter 314 thereby further adjusts the amplitudes of the first scan signals Tx11-Tx1m to output the second scan signals Tx21-Tx2m with the level of the second supplying voltage V2. The amplitudes of the second scan signals Tx21-Tx2m herein are greater than the amplitudes of the first scan signals Tx11-Tx1m.

In this way, the driving device 300 can adjust the driving capacity of the output scan signals according to different touch conditions to further save the whole power consumption.

In addition to use AP to input the user command OC by the operator so as to make the microprocessor to control the power supply part 320, the driving device 300 of the embodiment can also determine different touch conditions according to the received sensed signals Rx1-Rxn so as to control the power supply part 320. That is to say, the control part 330 can control the power switching unit 324 to switch and output one of the supplying voltages (for example, the first supplying voltage V1 and the second supplying voltage V2) according to the sensed signals Rx1-Rxn generated by the capacitive touch panel 10.

Specifically, in a driving device of a usual capacitive touch panel, the functions of driving and sensing are normally integrated into a sensor IC. In the embodiment, the driving device 300 uses the AFE processor 312 and the microprocessor 332 to fulfill the function similar to the sensor IC. At the time, the functions of generating the scan signals and receiving and analyzing the sensed signals are simultaneously fulfilled. Therefore, the microprocessor 332 can use different analyzing and processing methods to further determine the corresponding touch conditions according to the received sensed signals Rx1-Rxn.

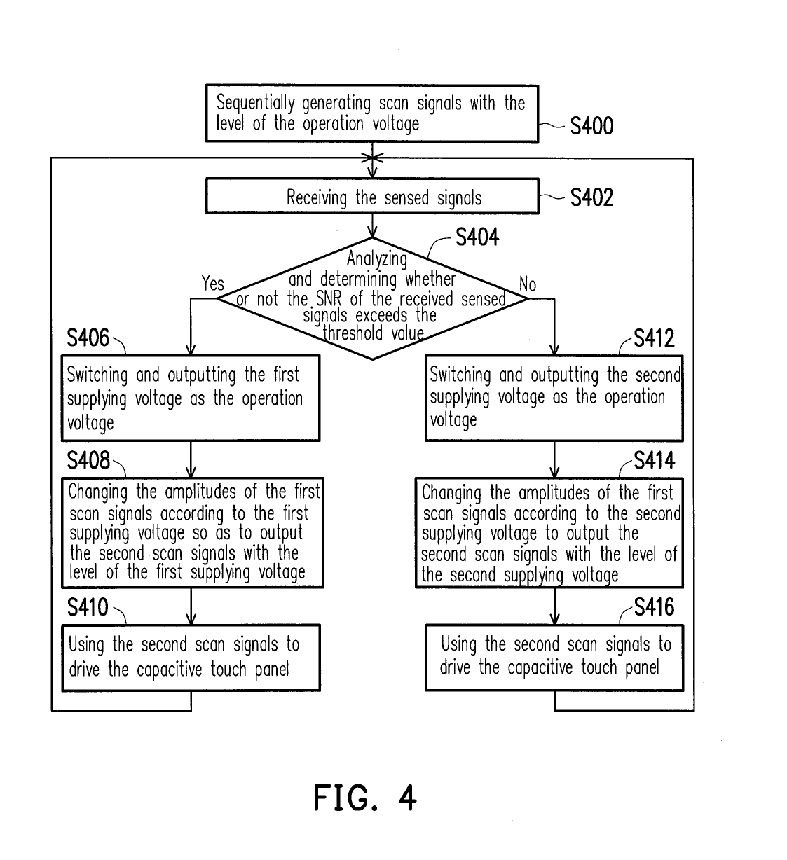

For example, the microprocessor 332 in the control part 330 can determine the type of the touch media by determining whether or not the SNR of the received sensed signals Rx1-Rxn exceeds the specified threshold value, as shown by FIG. 4, which is a flowchart of the steps of a touch panel driving method according to the embodiment of FIG. 3.

In the beginning state where the driving device 300 starts driving the capacitive touch panel 10, the power switching unit 324 outputs the first supplying voltage V1 with a lower level as the operation voltage Vs so that the level shifter 314 in the beginning state changes the amplitudes of the first scan signals Tx11-Tx1m in response to the first supplying voltage V1 and sequentially generates the second scan signals Tx21-Tx2m to drive the capacitive touch panel 10. In other words, in the beginning state for the driving device 300 to start driving the capacitive touch panel 10, the second scan signals Tx21-Tx2m with a lower driving capacity are configured to drive the capacitive touch panel 10 to save the power consumption

At the time, the driving method takes the touch state of a first touch medium (finger) and a second touch medium (touch stylus) as an example, which the present invention is not limited to and any touch medium able to generate two different capacitance variations is adapted to the driving method of the embodiment of the invention.

Referring to FIGS. 3 and 4, after the level shifter 314 adjusts the amplitudes of the first scan signals Tx11-Tx1m according to the initial operation voltage Vs (herein, the first supplying voltage V1 with a lower driving capacity is taken as an example) and sequentially generate the second scan signals Tx21-Tx2m with the operation voltage Vs (the first supplying voltage V1 herein) (step S400), the AFE processor 312 would receive the sensed signals Rx1-Rxn generated by the capacitive touch panel 10 (step S402) to make the microprocessor 332 analyze and determine whether or not the SNR of the received sensed signals Rx1-Rxn exceeds the threshold value (step S404).

When the SNR exceeds the threshold value, it indicates the touch medium is finger and the microprocessor 332 controls the power switching unit 324 to switch and output the first supplying voltage V1 as the operation voltage Vs (step S406). At the time, the AFE processor 312 needs changing the amplitudes of the first scan signals Tx11-Tx1m according to the first supplying voltage V1 so as to output the second scan signals Tx21-Tx2m with the level of the first supplying voltage V1 (step 5408) and use the second scan signals to drive the capacitive touch panel 10 (step S410).

At the time, since the capacitive touch panel 10 in the beginning state starts driving the capacitive touch panel 10 with the second scan signals Tx21-Tx2m with the level of the first supplying voltage, i.e., in the situation where the microprocessor 332 determines that the touch medium is finger according to the sensed signals with the SNR exceeding the threshold value, the driving device 300 would not change the level of the sensed signals and durably drive the capacitive touch panel 10 by using the scan signals with a lower level.

On the other hand, when the operator uses the touch stylus as touch medium to conduct touching operation on the capacitive touch panel 10, since the contact area between the touch stylus and the capacitive touch panel 10 is smaller so that the capacitive touch panel 10 accordingly generates the sensed signals Rx1-Rxn with SNR lower than the threshold value.

Therefore, the microprocessor 332 would control the power switching unit 324 to switch and output the second supplying voltage V2 as the operation voltage Vs (step S412), which makes the level shifter 314 change the amplitudes of the first scan signals Tx11-Tx1m according to the second supplying voltage V2 to output the amplitudes of the second scan signals Tx21-Tx2m with the level of the second supplying voltage V2 (step S414) and use the second scan signals Tx21-Tx2m to drive the capacitive touch panel 10 (step S416). The level of the second supplying voltage V2 herein would be higher than the level of the first supplying voltage V1, and the amplitudes of the second scan signals Tx21-Tx2m with the level of the first supplying voltage V1 are less than the amplitudes of the second scan signals Tx21-Tx2m with the level of the second supplying voltage V2.

In other words, for the situation where the microprocessor 332 determines that the operator uses the touch stylus as the touch medium to touch the capacitive touch panel 10 according to the sensed signals with the SNR lower than the threshold value, the driving device 300 would increase the driving capacity of the scan signals for driving the capacitive touch panel 10, which can thereby advance the SNR of the output sensed signals Rx 1 -Rxn so that the microprocessor 332 can correctly determine the touching actions/events on the capacitive touch panel 10. Based on the above-mentioned driving way, only in the need of sensing the touching actions/events of the touch stylus, the driving device 300 would switch and output the sensed signals with a higher level so as to reduce the whole power consumption.

In addition, the driving device 300 would repeat steps S402-S416 to durably determine whether or not the SNR of the sensed signals Rx1-Rxn exceed the threshold value so as to output the corresponding scan signals. When the operator changes using the touch stylus into using finger for touching actions, or changes using finger into using the touch stylus for touching actions, the microprocessor 332 can control the power switching unit 324 to output the corresponding operation voltage Vs again according to the above-mentioned steps, so that the level shifter 314 is switched again to output the scan signals with a lower or higher driving capacity to drive the capacitive touch panel 10.

It should be noted that in a real application, the steps such as analyzing and determining whether or not the SNR exceed the threshold value can be conducted by the AFE processor 312 in the driving part 310 or the microprocessor 332 in the control part 330, and the above-mentioned steps of calculating and determining can be conducted by an independent operation unit (not shown) in the driving part 310, which the present invention is not limited to. In fact, the implementation of the embodiment is an exemplary example only.

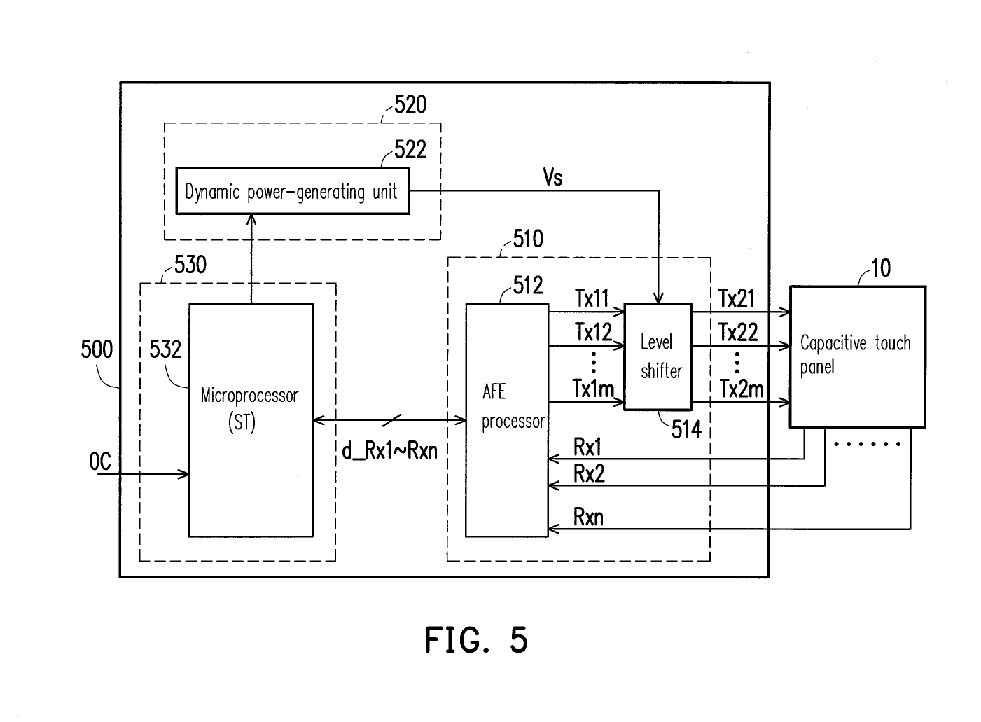

FIG. 5 is a schematic diagram of a driving device 500 according to an embodiment of the present invention. Referring to FIG. 5, the driving device 500, in the same way, includes a driving part 510, a power supply part 520 and a control part 530. The driving part 510 also includes an AFE processor 512 and a level shifter 514, while the power supply part 520 includes a dynamic power-generating unit 522 and the control part 530 includes a microprocessor 532.

In the embodiment, the architectures and the functions of the driving part 510 and the control part 530 are the same as the embodiment of FIG. 3, which is omitted to describe.

The difference from the embodiment of FIG. 3 rests in the microprocessor 532 of the embodiment can control the dynamic power-generating unit 522 according to the sensed signals Rx1-Rxn so as to dynamically generate an adjustable voltage as the operation voltage Vs. As a result, the driving device 500 can further output corresponding scan signals with different driving capacity to drive the capacitive touch panel 10 according to multiple touch conditions so as to realize smart energy-saving driving scheme.

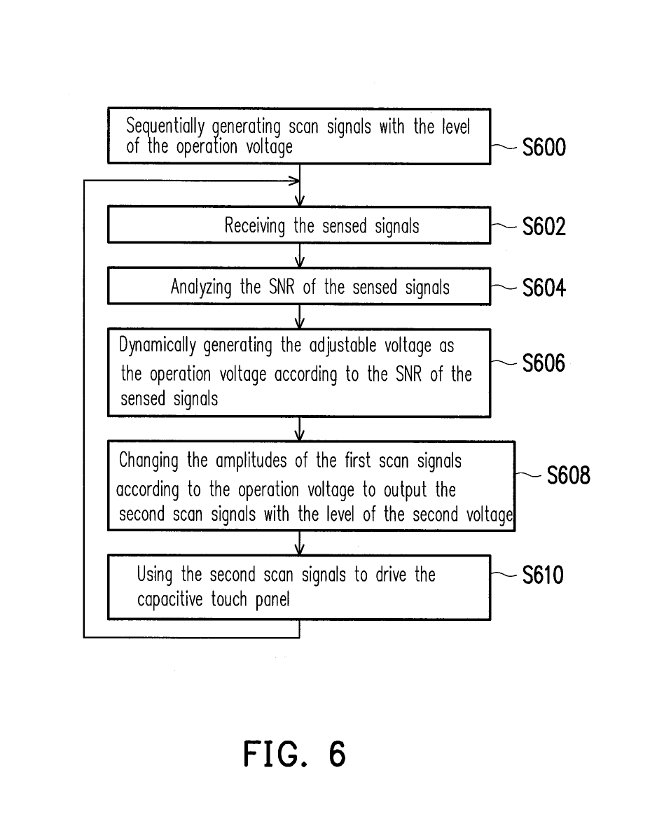

The driving method of the embodiment is shown by FIG. 6, which is a flowchart of the steps of a touch panel driving method according to the embodiment of FIG. 5. Referring to FIGS. 5 and 6, first, the level shifter 514 of the driving part 510 adjusts the amplitudes of the first scan signals Tx11-Tx1m output by the AFE processor 512 according to the predetermined initial operation voltage Vs and sequentially generates the second scan signals Tx21-Tx2m with the initial operation voltage Vs to drive the capacitive touch panel 10 (step S600). After the AFE processor 512 receives the sensed signals Rx1-Rxn returned by the capacitive touch panel 10 (step S602), the microprocessor 532 analyzes the SNR of the sensed signals Rx1-Rxn (step S604) to control the power-generating unit 522 according to the SNR of the sensed signals Rx1-Rxn and make the power-generating unit 522 dynamically generate the adjustable voltage as the operation voltage Vs (step S606). As a result, the level shifter 514 changes the amplitudes of the first scan signals Tx11-Tx1m according to the operation voltage Vs to output the second scan signals Tx21-Tx2m with the level of the operation voltage Vs (step S608) and use the second scan signals Tx21-Tx2m to drive the capacitive touch panel 10 (step S610).

In more details, under different touch conditions, different capacitance variations between the electrodes on the capacitive touch panel 10 are generated. The larger the contact area between the touch medium and the capacitive touch panel 10, the larger the capacitance variations are. On the contrary, the smaller the contact area between the touch medium and the capacitive touch panel 10, the relatively smaller the capacitance variations are. At the time, the capacitive touch panel 10 would generate the sensed signals with corresponding SNR. For example, by using two fingers, three or four fingers to touch the capacitive touch panel, the SNR of the generated sensed signals are different from each other.

For example, a displacement lookup table (ST) is built in the microprocessor 532, and the driving device 500 can realize the driving method with dynamically controlling the control part 530 through inquiring the displacement lookup table (ST).

Thus, the designer can put the corresponding mappings between different SNR and the adjustable voltages in advance into the built-in displacement lookup table ST in the microprocessor 532 so that the microprocessor 532 can further look up the table according to the SNR of the received sensed signals Rx1-Rxn to control the dynamic power-generating unit 522 for generating the corresponding operation voltage Vs, and in this way, the driving device 500 can adjust the driving capacity of the scan signals output therefrom according to different touch conditions, which the present invention is not limited to.

In addition, the driving device 500 in the embodiment can also use the way of inputting the user command OC similar to the embodiment of FIG. 3 to drive the capacitive touch panel 10 through the scan signals with different driving capacities. Since the driving mode is similar to the previous embodiment, the content is omitted to describe.

In summary, the touch panel driving device and the driving method thereof in the embodiments of the invention are able to manually input the user commands through an application (AP), or automatically provide the scan signals with corresponding driving capacity to drive the capacitive touch panel according to the sensed signals under different touch conditions, which enables a driving device using the above-mentioned driving method saving the power consumption during driving.

It will be apparent to those skilled in the art that the descriptions above are several preferred embodiments of the present invention only, which does not limit the implementing range of the present invention. Various modifications and variations can be made to the structure of the present invention without departing from the scope or spirit of the invention.

What is claimed is:

1. A touch panel driving device, configured to drive a capacitive touch panel, comprising:
a driving part, configured to sequentially generate a plurality of scan signals with level of an operation voltage in response to the operation voltage, so as to drive the capacitive touch panel;
a power supply part, coupled to the driving part, configured to supply the operation voltage to the driving part; and
a control part, coupled to the driving part and the power supply part, configured to control operations of the driving part and the power supply part, and adjust the operation voltage supplied by the power supply part in response to different touch conditions, so as to change amplitudes of the scan signals.

2. The touch panel driving device as claimed in claim 1, wherein the power supply part comprises:
a power-generating unit, configured to at least generate a first supplying voltage and a second supplying voltage, wherein level of the first supplying voltage is less than that of the second supplying voltage; and
a power switching unit, coupled to the power-generating unit, the driving part and the control part, configured to receive the first supplying voltage and the second supplying voltage, and switch and output one of the first supplying voltage and the second supplying voltage as the operation voltage in response to the control of the control part.

3. The touch panel driving device as claimed in claim 2, wherein the control part, in response to a user command, controls the power switching unit to switch and output one of the first supplying voltage and the second supplying voltage as the operation voltage.

4. The touch panel driving device as claimed in claim 2, wherein the control part controls the power switching unit according to a plurality of sensed signals generated by the capacitive touch panel, so as to switch and output one of the supplying voltages as the operation voltage.

5. The touch panel driving device as claimed in claim 4, wherein the control part is further configured to analyze and determine whether or not a signal to noise ratio (SNR) of the sensed signals exceeds a threshold value,
wherein when the control part determines that the SNR of the sensed signals exceeds the threshold value, the control part controls the power switching unit to switch and output the first supplying voltage as the operation voltage,
wherein when the control part determines that the SNR of the sensed signals does not exceed the threshold value, the control part controls the power switching unit to switch and output the second supplying voltage as the operation voltage,
wherein the level of the first supplying voltage is less than that of the second supplying voltage, such that amplitude of each of the scan signals with the level of the first supplying voltage is less than that of each of the scan signals with the level of the second supplying voltage.

6. The touch panel driving device as claimed in claim 1, wherein the power supply part comprises:
a dynamic power-generating unit, configured to dynamically generate an adjustable voltage as the operation voltage in response to the control of the control part.

7. The touch panel driving device as claimed in claim 6, wherein the control part controls the dynamic power-generating unit to dynamically generate the adjustable voltage according to a plurality of sensed signals generated by the capacitive touch panel.

8. The touch panel driving device as claimed in claim 7, wherein the control part further controls the dynamic power-generating unit to dynamically generate the adjustable voltage by analyzing a signal to noise ratio (SNR) of the sensed signals.

9. The touch panel driving device as claimed in claim 1, wherein the driving part comprises:
an analog front-end processor, coupled to the control part, configured to sequentially generate a plurality of first scan signals, wherein the analog front-end processor receives a plurality of sensed signals generated by the capacitive touch panel and thereby performing an analog-to-digital conversion on the sensed signals, so as to return the converted sensed signals to the control part; and
a level shifter, coupled to the power supply part and the analog front-end processor, wherein the level shifter receives the first scan signals and, in response to the operation voltage, adjusts amplitudes of the first scan signals to thereby sequentially generate a plurality of second scan signals with the level of the operation voltage.

10. The touch panel driving device as claimed in claim 1, wherein the control part comprises:
a microprocessor, configured to receive a plurality of sensed signals returned by the driving part and thereby performing a signal processing on the sensed signals, so as to recognize touch event on the capacitive touch panel, wherein the microprocessor controls the power supply part in response to different touch conditions.

11. A touch panel driving method, configured to drive a capacitive touch panel, comprising:
sequentially generating a plurality of scan signals with level of an operation voltage;
adjusting the operation voltage in response to different touch conditions; and
changing amplitudes of the scan signals in response to the adjusted operation voltage and thereby driving the capacitive touch panel.

12. The touch panel driving method as claimed in claim 11, wherein the step of adjusting the operation voltage in response to different touch conditions comprises:
switching and outputting one of a first supplying voltage and a second supplying voltage in response to a user command as the operation voltage.

13. The touch panel driving method as claimed in claim 11, wherein the step of adjusting the operation voltage in response to different touch conditions comprises:
switching and outputting one of a plurality of supplying voltages as the operation voltage according to a plurality of sensed signals generated by the capacitive touch panel.

14. The touch panel driving method as claimed in claim 13, wherein the supplying voltages at least comprise a first supplying voltage and a second supplying voltage, and the step of switching and outputting one of the supplying voltages as the operation voltage according to the sensed signals generated by the capacitive touch panel comprises:
receiving the sensed signals;
analyzing and determining whether or not a signal to noise ratio (SNR) of the sensed signals exceeds a threshold value;
when the SNR of the sensed signals exceeds the threshold value, switching and outputting the first supplying voltage as the operation voltage; and
when the SNR of the sensed signals does not exceed the threshold value, switching and outputting the second supplying voltage as the operation voltage, wherein level of the first supplying voltage is less than that of the second supplying voltage, and amplitude of each of the scan signals with the level of the first supplying voltage is less than that of each of the scan signals with the level of the second supplying voltage.

15. The touch panel driving method as claimed in claim 14, wherein when the operation voltage is the first supplying voltage, the step of changing the amplitudes of the scan signals in response to the adjusted operation voltage and thereby driving the capacitive touch panel comprises:
changing amplitudes of a plurality of first scan signals according to the first supplying voltage so as to output a plurality of second scan signals with the level of the first supplying voltage; and
driving the capacitive touch panel by using the second scan signals.

16. The touch panel driving method as claimed in claim 14, wherein when the operation voltage is the second supplying voltage, the step of changing the amplitudes of the scan signals in response to the adjusted operation voltage and thereby driving the capacitive touch panel comprises:
changing amplitudes of a plurality of first scan signals according to the second supplying voltage so as to output a plurality of second scan signals with the level of the second supplying voltage; and
driving the capacitive touch panel by using the second scan signals.

17. The touch panel driving method as claimed in claim 11, wherein the step of adjusting the operation voltage in response to different touch conditions comprises:
dynamically generating an adjustable voltage as the operation voltage according to a plurality of sensed signals generated by the capacitive touch panel.

18. The touch panel driving method as claimed in claim 17, wherein the step of dynamically generating the adjustable voltage as the operation voltage according to the sensed signals generated by the capacitive touch panel comprises:
receiving the sensed signals;
analyzing a signal to noise ratio (SNR) of the sensed signals; and
dynamically generating the adjustable voltage as the operation voltage according to the signal to noise ratio (SNR) of the sensed signals.

19. The touch panel driving method as claimed in claim 18, wherein the step of changing the amplitudes of the scan signals in response to the adjusted operation voltage comprises:
changing amplitudes of a plurality of first scan signals according to the operation voltage so as to output a plurality of second scan signals with the level of the operation voltage.
